(19) United States
(12) Patent Application Publication
(10) Pub. No.: US 2025/0356242 A1
(43) Pub. Date: Nov. 20, 2025

(54) ADVANCED EXPLOITATION OF MULTITHREADING TO BOOST MACHINE LEARNING INFERENCE PERFORMANCE FOR DECISION-TREE BASED ENSEMBLES

(71) Applicant: International Business Machines Corporation, Armonk, NY (US)

(72) Inventor: Jan van Lunteren, Gattikon (CH)

(21) Appl. No.: 18/596,713

(22) Filed: Mar. 6, 2024

(51) Int. Cl. G06N 20/00; G06F 9/52

(52) U.S. Cl. CPC G06N 20/00; G06F 9/524

(57) ABSTRACT

A method for performing machine learning decision-tree based inferences includes generating multiple CPU threads on an inference function server and determining if an inference request which requires a tree traversal operation has been received. If an inference request which requires the tree traversal operation has been received, then immediately executing the tree traversal operation. If an inference request which requires the tree traversal operation has not been received, then determining if a stop thread request has been received, wherein if a stop thread request has been received, then stopping the CPU thread.

### BACKGROUND

The present invention generally relates to decision-tree based ensembles, and more particularly, to the exploitation of multithreading in decision-tree based ensembles.

A decision tree is a non-parametric supervised learning algorithm which is used to accomplish classification and regression tasks. Typically, the decision tree includes a hierarchical tree structure which includes a root node, branches, internal nodes and leaf nodes. The decision tree is a model that is used in decision support to represent decisions and their potential outcomes, while incorporating utility, resource expenses and chance events. Essentially, decision trees are a tool that have application across multiple different areas, where the decision typically starts with a root node and ends with a decision made by leaves.

Referring to FIG. 1, the decision tree includes split nodes and leaf nodes, where each split node represents a selection of an input sample feature and a comparison of that sample feature to a stored threshold. Accordingly, if the sample feature is less than the threshold, the split node will branch to a left child node and if the sample feature is greater than or equal to the threshold, then the split node will branch to the right child node. When all of the tree traversals have reached leaf nodes (i.e., no more decisions) then the overall result is derived. It should be appreciated that the decision tree basic operation allows for parallelism with the input sample batches and trees within the model.

A decision tree ensemble is a machine learning technique that attempts to make better predictions or classifications by combining multiple decision trees. Each decision tree in the ensemble typically follows a simple “if-then” rule, where input data is split into smaller groups based on different features. Each split creates branches and at the end of these branches are the predictions and/or classifications. One benefit of this is that when many decision trees are working together in an ensemble, one tree's strengths may cover another tree's weaknesses and thus, they can correct each other's mistakes. The ensemble then combines the individual predictions from all of the decision trees to determine a final, more accurate prediction.

Two of the more popular and most frequently used decision tree ensemble models in Machine Language (ML) algorithms include Random Forest (RF) ensembles and Gradient-Boosted (GB) ensembles. Random Forest (RF) ensembles is an ensemble learning method that combines multiple independent decision trees to make more accurate predictions, where each of the decision trees are trained on a different subset of the data. Each tree in the forest is trained with a random selection of data points and features to add diversity of the trees and to reduce the effect of overfitting. Each tree of the RF ensemble makes its own prediction, where the final prediction is determined by a majority ‘vote’ among the individual tree predictions. Thus, RF combine reduces the weakness of the multiple decision trees by combining their strengths.

Gradient-Boosted (GB) ensembles builds decision trees sequentially, where each new tree attempts to correct the mistakes of the previous decision trees. The GB algorithm assigns more weight to data points that were incorrectly predicted by a previous decision tree, thereby making the new decision tree focus on getting the prediction correct. The final prediction is the weighted sum of the predictions from all of the decision trees, where the weights are determined based on how well each decision tree performed. Accordingly, GB produces a predictive model by iteratively improving on the mistakes of previous decision trees.

While most inference libraries/platforms (i.e., XGBoost, LightGBM, Scikit-Learn, ONNX Runtime, etc.) focus on offline processing of long batches of data, emerging applications require real-time online predictions using only one or a few input samples. For example, the financial services industry typically use decision trees to score credit card transactions for real-time fraud detection and anti-money laundering operations. Time-critical enterprise applications typically have Service Level Agreements (SLAs) in the low millisecond range and low latency operation is critical because the inference operation is part of a real-time processing pipeline, where individual transactions or small batches of transactions are processed on-the-fly. Accordingly, Central Processing Unit (CPU) multithreading is essential for achieving high inference performance.

Unfortunately, however, starting multiple threads take time and can substantially impact the inference latency in a negative way for individual transactions and small batches of transactions (for longer transaction batches, the thread start time can be amortized).

### SUMMARY

A method for performing machine learning decision-tree based inferences includes generating multiple CPU threads on an inference function server and determining if an inference request which requires a tree traversal operation has been received. If an inference request which requires the tree traversal operation has been received, then immediately executing the tree traversal operation. If an inference request which requires the tree traversal operation has not been received, then determining if a stop thread request has been received, wherein if a stop thread request has been received, then stopping the CPU thread.

Embodiments of the invention are also directed to computer-implemented methods and computer program products having substantially the same features and functionality as the computer system described above.

Additional technical features and benefits are realized through the techniques of the present invention. Embodiments considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows multiple examples decision trees from root node to split nodes to leaf nodes;

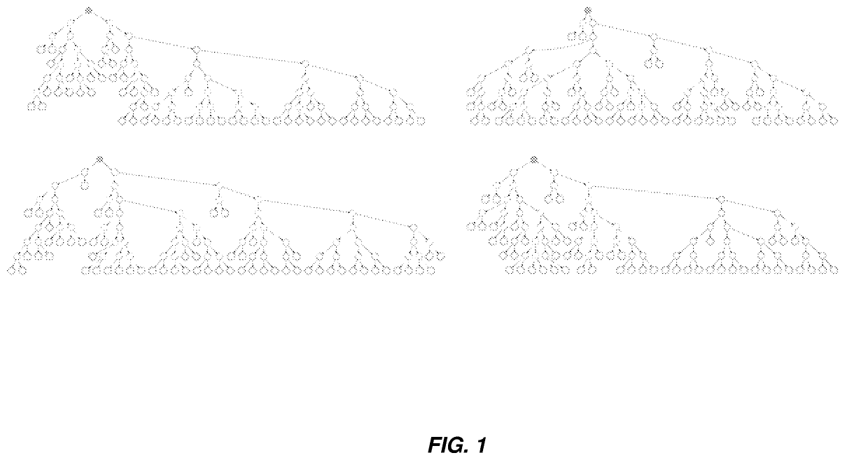

FIG. 2A is an operational flow block diagram illustrating a Main Execution/Control Thread for created and starting the CPU threads, in accordance with an embodiment of the invention;

FIG. 2B is an operational flow block diagram illustrating a Main Execution/Control Thread for created and starting the CPU threads, in accordance with another embodiment of the invention;

FIG. 3A is an operational flow block diagram illustrating a flow operation for each individual tree-traversal thread, in accordance with an embodiment of the invention;

FIG. 3B is an operational flow block diagram illustrating a flow operation for each individual tree-traversal thread, in accordance with another embodiment of the invention;

FIG. 4 is an operational block diagram illustrating a method for performing machine learning decision-tree based inferences, in accordance with an embodiment of the invention; and

FIG. 5 shows a block diagram of an example computer system for use in accordance with one or more embodiments of the present invention.

### DETAILED DESCRIPTION

As discussed briefly above, a decision tree ensemble is a machine learning technique that attempts to make better predictions or classifications by combining multiple decision trees. Each decision tree in the ensemble typically follows a simple “if-then” rule, where input data is split into smaller groups based on different features. Each split creates branches and at the end of these branches are the predictions and/or classifications. While most inference libraries/platforms (i.e., XGBoost, LightGBM, Scikit-Learn, ONNX Runtime, etc.) focus on offline processing of long batches of data, emerging applications require real-time online predictions using only one or a few input samples. Time-critical enterprise applications typically have Service Level Agreements (SLAs) in the low millisecond range and low latency operation is critical because the inference operation is part of a real-time processing pipeline, where individual transactions or small batches of transactions are processed on-the-fly. Accordingly, CPU multithreading is essential for achieving high inference performance. Unfortunately, however, starting multiple threads take time and can substantially impact the inference latency in a negative way for individual transactions and small batches of transactions (for longer transaction batches, the thread start time can be amortized).

As discussed further hereinbelow, one embodiment of the invention provides a novel method for exploiting CPU threads (real-time inference of short batches) by implementing multiple tree-traversal engines running in separate CPU threads, where the separate CPU threads are kept active all of the time and can reduce latency by immediately reacting and processing any prediction request that is received. This novel method allows for the use of spinlocks for synchronizing multithreaded tree traversals for ML scoring and for allocating the trees/input samples to each traversal thread.

In an embodiment, the invention uses spinlocks to implement extremely fast reaction times by tree traversal threads, where the spinlocks may be implemented using atomic operations (i.e., atomics). In atomics, the operations are conducted in sequences of instructions that guarantee atomic access and updates of shared single word variables. Accordingly, when performing atomic operations, only one read or write operation can be performed at a time. Thus, if a program reads a property atomically, then that property cannot change during the read operation. However, in another embodiment, the method may be implemented using mutexes which allow other non-tree-traversal threads to be scheduled during longer waiting times, but which may be slower than atomics. Tree-traversal thread operations apply Boolean atomics to trigger the tree-traversal thread to execute requested traversals (i.e., traversal_start condition), to request tree-traversal threads to stop its operation (i.e., traversal_end condition), and to indicate that traversals are ready, where selected trees and inputs are indicated using standard (i.e., non-atomics) data structures (e.g., arrays) (i.e., ready condition). Moreover, threads are started/stopped when the prediction function (i.e., server) is started/stopped.

If there are no tree-traversals to be performed, then the method executes lower-priority tasks as part of the spinlock. These lower-priority tasks are executed in small steps (e.g., a few instructions at a time), after which the traversal_start condition is tested to determine if any tree-traversals must be performed for incoming prediction requests. In another embodiment, a list of lower-priority tasks may be provided as part of a task queue. It should be appreciated that the testing of the traversal_start condition is fully under the control of the executed code in the thread as part of the spinlock. Thus, the thread scheduler (part of the Operating System (OS)) has no influence on the scheduling of the lower-priority tasks and therefore will not delay the processing of any incoming tree-traversal requests.

According to an embodiment, generally the method includes starting multiple CPU threads for executing decision-tree traversals when the inference function/server is started. Each CPU thread uses a spinlock to determine if an inference request has been received for which the CPU thread needs to execute one or more tree traversals (using selected trees and input samples). If a request has been received, then the tree traversal operations will be executed immediately by the CPU thread. If there are no tree traversal requests, then the CPU thread will check to see if there is a request to stop the CPU thread. If there is a request to stop the CPU thread, the CPU thread will will exit the spinlock so the CPU thread can be stopped and joined when the inference function/server is stopped. If no traversal or stop requests have been received, then optionally short sequences of lower-priority operations can be executed during a ‘down time’ and before the CPU thread tries to acquire the lock again.

Essentially, the invention involves a computer-implemented method for performing machine learning inference based on decision trees, including random forests and gradient-boosted trees. The method includes multiple decision-tree traversal functions that are each executed in a separate CPU thread, with all of the CPU threads being created and started by the main execution thread when the inference function/server is started. Each CPU-thread-based traversal function uses a spinlock to determine if an inference request has been received from the main execution thread for which the traversal function needs to execute one or more tree traversals in order to process selected input samples for selected trees within the decision-tree based model. It should be noted that the tree and sample selection is also being performed as part of the main execution thread. If an inference request has been received, then the required tree-traversal operations will be executed immediately by the appropriate CPU thread. If no inference request has been received, then the CPU thread will check to see if a request for stopping the CPU thread has been received, which typically happens when the inference function/server is stopped. If a stop request is received, then the CPU thread will exit the spinlock so that it can be stopped (joined) by the main execution thread. On the other hand, if no inference or stop requests have been received by a CPU thread, then optionally short sequences of lower-priority operations can be executed before the CPU thread tries to acquire the lock again.

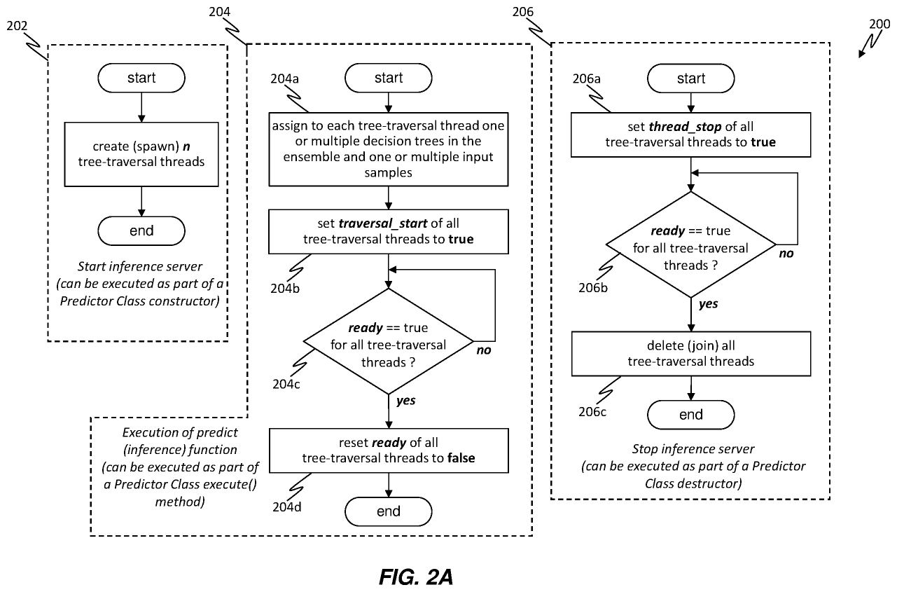

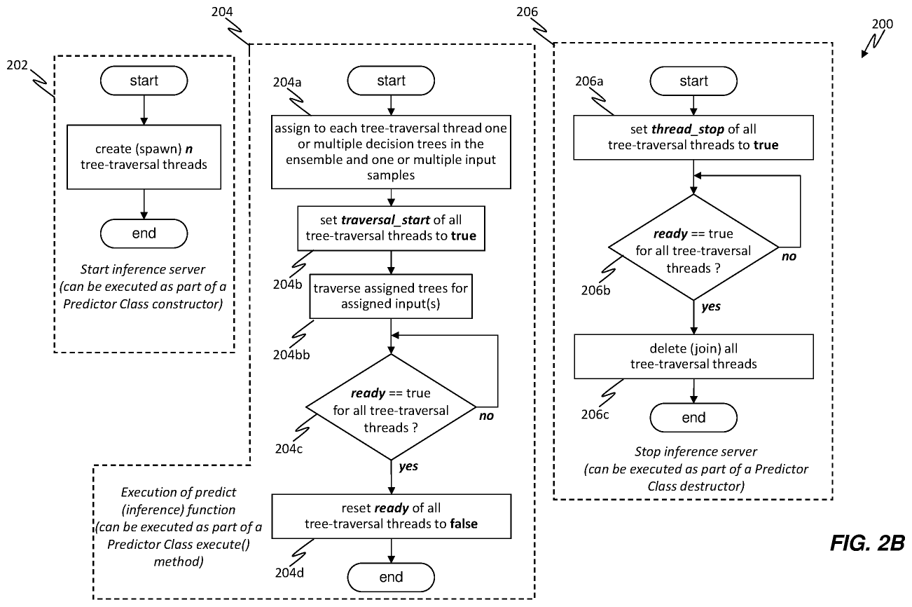

Referring to FIG. 2A, a flow diagram 200 illustrating an embodiment of an overall method for creating/starting one or more CPU threads to implement multiple decision-tree traversal functions using a main execution/control thread is shown and includes starting the inference function server 202 to create or spawn an n number of tree-traversal threads to process a decision tree-based ensemble. The method further includes executing a predict inference function 204 which assigns each of the one or more of the decision trees in the ensemble and one or more multiple input samples to one of the n number of tree-traversal threads 204a. The tree-traversal start atomics indicator (traversal_start) for all of the tree-traversal threads is then set to true 204b. The tree-traversal ready atomics indicators (ready) are monitored 204c until all of the tree-traversal ready indicators are set to true. Once all of the tree-traversal ready indicators are set to true, the ready indicators of all of the tree-traversal threads are then reset to false 204d. It should be appreciated that this function may be executed as part of a Predictor Class execute ( ) method in a C++ program. The method further includes stopping the inference server 206 to stop all of the tree-traversal threads. This may be accomplished by setting all of the thread stop atomics indicators (thread_stop) to true 206a. The thread ready atomics indicators (ready) are monitored 206b until all of the thread ready atomics indicators (ready) have been set to true. Once the ready atomics indicators for all of the tree-traversal threads are set to true, all of the tree-traversal threads are deleted and joined 206c. It should be appreciated that the stop inference server may be executed as part of a Predictor Class destructor in a C++ program.

It should be appreciated that, in an embodiment, assigning the decision trees and/or input samples to the tree-traversal threads may be accomplished using standard variables and/or arrays of variables without the need for atomics or similar structures as the synchronization and potential race conditions are already being addressed by the traversal_start atomics, thread_stop atomics, and ready atomics. In another embodiment, the main execution/control thread may also process (i.e., traverse) a part of the decision trees within the ensemble. For example, in an embodiment and referring to FIG. 2B, a function operation which is configured to traverse assigned trees for assigned inputs may be implemented during the tree-traversal thread method. This is shown as a traversal function disposed immediately following the set traversal_start atomics function 204bb.

In still yet another embodiment, the number of active threads may be changed during the time that the inference server is running and as such, this would require an additional function (method), that either starts additional threads or stops part of the active threads.

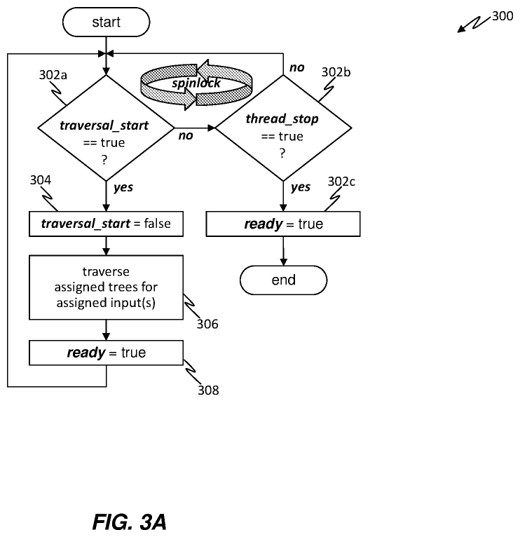

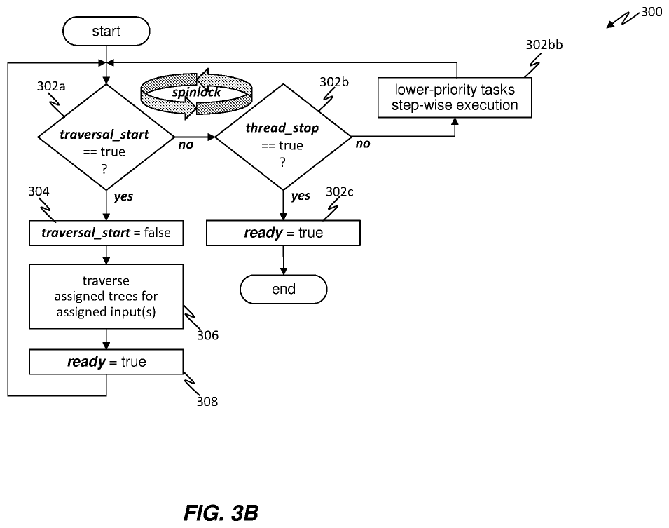

Referring to FIG. 3A, a flow diagram 300 illustrating an embodiment for implementing each individual tree-traversal thread is shown and includes starting the CPU thread in a spinlock configuration to implement a tree traversal start (traversal_start) atomics function. The tree-traversal start atomics indicator (traversal_start) is checked 302a to see if the tree-traversal start indicator is set to true. If the tree-traversal start indicator (traversal_start) is not set to true, then the thread stop atomics indicator (thread_stop) is checked 302b to see if the thread stop atomics indicator (thread_stop) is set to true. If the thread stop (thread_stop) atomics indicator is set to true, then the ready atomics indicator is set to true 302c and the thread is ended. However, if the thread stop atomics indicator (thread_stop) is not set to true, then the tree-traversal start atomics indicator (traversal_start) is again checked 302a to see if the tree-traversal start indicator is set to true. This process is repeated until the tree-traversal start atomics indicator (traversal_start) is set to true. Once the tree-traversal start atomics indicator (traversal_start) is set to true, then the tree-traversal start atomics indicator (traversal_start) is reset to false 304 and the assigned/selected trees are traversed for assigned input(s) 306. Once the assigned/selected trees are traversed for assigned input(s), the ready atomics indicator is set to true 308 and the process is repeated.

In another embodiment, the individual tree-traversal thread implementation may also be configured to accomplish lower-priority tasks in a step-wise fashion during down times of the CPU thread processing. For example, in an embodiment and referring to FIG. 3B, a flow diagram 300A illustrating implementation of the individual tree-traversal thread where the implementation is configured to accomplish lower-priority tasks is shown and is essentially identical to the implementation of the individual tree-traversal thread where the implementation is not configured to accomplish lower-priority tasks, with the exception that if the thread stop (thread_stop) atomics indicator is not set to true, then the lower priority tasks may be executed 302bb and then the tree-traversal start atomics indicator (traversal_start) is again checked 302a to see if the tree-traversal start indicator is set to true.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing machine learning decision tree-based inferences 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

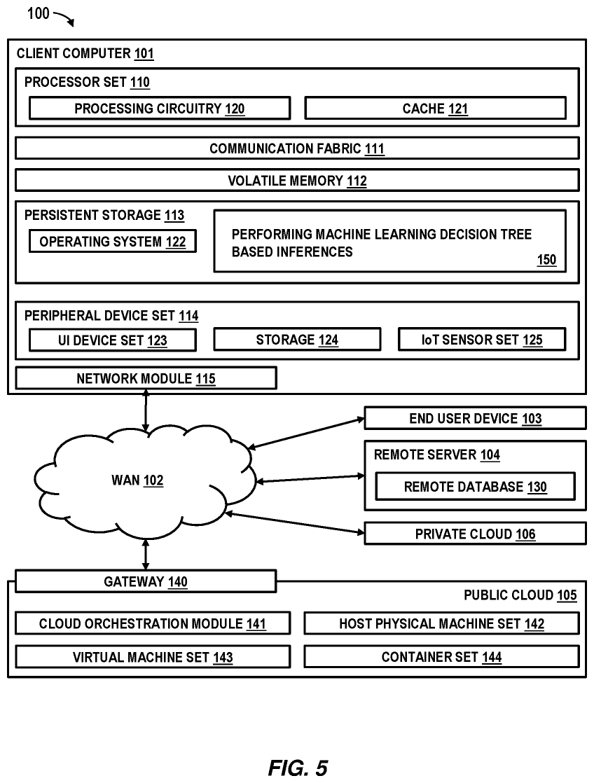

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 5. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In accordance with an embodiment, the invention provides a novel method for exploiting CPU threads (real-time inference of short batches) by implementing multiple tree-traversal engines running in separate CPU threads, where the separate CPU threads are kept active all of the time and can reduce latency by immediately reacting and processing any prediction request that is received. This novel method allows for the use of spinlocks for synchronizing multithreaded tree traversals for ML scoring and for allocating the trees/input samples to each traversal thread.

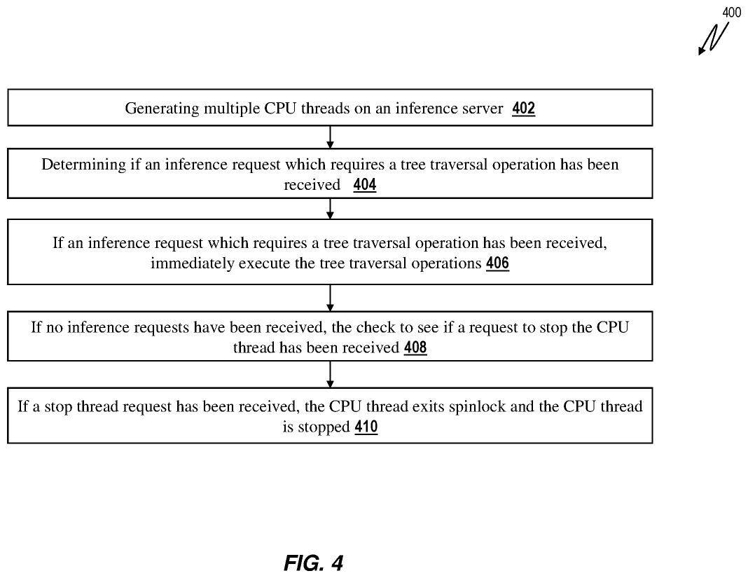

Referring to FIG. 4, an operational block diagram illustrating an embodiment of a method 400 for performing machine learning decision-tree based inferences is shown and includes generating and activating multiple CPU threads on an inference function server, as shown in operational block 402. It should be appreciated that the multiple CPU threads are configured to execute decision tree traversals when the inference function server is started. The method includes applying a spinlock to each of the multiple CPU threads to determine if one or more inference requests which require a tree traversal has been received, as shown in operational block 404. If one or more inference requests which require a tree traversal has been received, then the CPU thread will immediately execute the tree-traversal operations, as shown in operational block 406. If no inference requests which require a tree traversal have been received, then the CPU will check to see if there is a request to stop the thread, as shown in operational block 408. It should be appreciated that, in one embodiment, this occurs when the inference function server is stopped. If a stop thread request is received, then the CPU thread exits the spinlock to allow the CPU thread to be stopped/joined, as shown in operational block 410. In an embodiment, if no tree-traversal or stop requests have been received by the CPU thread, then optionally short sequences of lower-priority operations may be executed before the CPU thread tries to acquire the spinlock again.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for performing machine learning decision-tree based inferences, the method comprising:
generating multiple CPU threads on an inference function server;
determining if an inference request which requires a tree traversal operation has been received, wherein:
if an inference request which requires the tree traversal operation has been received, then immediately executing the tree traversal operation; and
if an inference request which requires the tree traversal operation has not been received, then determining if a stop thread request has been received, wherein if a stop thread request has been received, then stopping the CPU thread.

2. The method of claim 1, wherein generating multiple CPU threads includes starting an inference function server to generate the multiple CPU threads, wherein the multiple CPU threads are configured to execute decision tree traversal operations upon starting the inference function server.

3. The method of claim 1, wherein determining if an inference request has been received includes the CPU threads acquiring a spinlock function for each of the multiple CPU threads to determine if one or more inference requests which require the tree traversal operation has been received.

4. The method of claim 3, wherein if no inference requests which requires a tree traversal operation or stop thread requests have been received, then the each of the multiple CPU threads will execute short sequences of lower-priority operations prior to the CPU threads attempting to reacquire the spinlock function.

5. The method of claim 1, wherein the CPU thread is configured to immediately perform the tree traversal operation upon determining if an inference request has been received.

6. The method of claim 1, wherein determining if a stop thread request has been received includes the CPU checking to see if the stop thread request has been received.

7. The method of claim 3, wherein if a stop thread request has been received, the CPU thread exits the spinlock function to allow the CPU thread to be stopped.

8. A computing system, comprising:
a machine learning system for implementing a method for performing machine learning decision-tree based inferences, wherein the method includes:
generating multiple CPU threads on an inference function server;
determining if an inference request which requires a tree traversal operation has been received, wherein:
if an inference request which requires the tree traversal operation has been received, then immediately executing the tree traversal operation; and
if an inference request which requires the tree traversal operation has not been received, then determining if a stop thread request has been received, wherein if a stop thread request has been received, then stopping the CPU thread.

9. The computing system of claim 8, wherein generating multiple CPU threads includes starting an inference function server to generate the multiple CPU threads, wherein the multiple CPU threads are configured to execute decision tree traversal operations upon starting the inference function server.

10. The computing system of claim 8, wherein determining if an inference request has been received includes the CPU threads acquiring a spinlock function for each of the multiple CPU threads to determine if one or more inference requests which require the tree traversal operation has been received.

11. The computing system of claim 10, wherein if no inference requests which requires a tree traversal operation or stop thread requests have been received, then the each of the multiple CPU threads will execute short sequences of lower-priority operations prior to the CPU threads attempting to reacquire the spinlock function.

12. The computing system of claim 8, wherein the CPU thread is configured to immediately perform the tree traversal operation upon determining if an inference request has been received.

13. The computing system of claim 8, wherein determining if a stop thread request has been received includes the CPU checking to see if the stop thread request has been received.

14. The computing system of claim 10, wherein if a stop thread request has been received, the CPU thread exits the spinlock function to allow the CPU thread to be stopped.

15. A computer program product comprising a computer readable storage medium having program instructions embodied therewith, the program instructions executable by a processor to cause the processor to perform operations for implementing method for performing machine learning decision-tree based inferences, the method comprising:
generating multiple CPU threads on an inference function server;
determining if an inference request which requires a tree traversal operation has been received, wherein:
if an inference request which requires the tree traversal operation has been received, then immediately executing the tree traversal operation; and
if an inference request which requires the tree traversal operation has not been received, then determining if a stop thread request has been received, wherein if a stop thread request has been received, then stopping the CPU thread.

16. The method of claim 15, wherein generating multiple CPU threads includes starting an inference function server to generate the multiple CPU threads, wherein the multiple CPU threads are configured to execute decision tree traversal operations upon starting the inference function server.

17. The method of claim 15, wherein determining if an inference request has been received includes the CPU threads acquiring a spinlock function for each of the multiple CPU threads to determine if one or more inference requests which require the tree traversal operation has been received.

18. The method of claim 17, wherein if no inference requests which requires a tree traversal operation or stop thread requests have been received, then the each of the multiple CPU threads will execute short sequences of lower-priority operations prior to the CPU threads attempting to reacquire the spinlock function.

19. The method of claim 15, wherein the CPU thread is configured to immediately perform the tree traversal operation upon determining if an inference request has been received.

20. The method of claim 17,
wherein determining if a stop thread request has been received includes the CPU checking to see if the stop thread request has been received, and
if a stop thread request has been received, the CPU thread exits the spinlock function to allow the CPU thread to be stopped.
